(19) United States
(12) Patent Application Publication
(10) Pub. No.: US 2008/0247296 A1
(43) Pub. Date: Oct. 9, 2008

(54) Optical Storage Disk and System Comprising a Disk with Non-Uniformly Spaced Tracks

(75) Inventor: Bin Yin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/088,510

(22) PCT Filed: Sep. 13, 2006
(86) PCT No.: PCT/IB2006/053254

§ 371 Date: Mar. 28, 2008

(30) Foreign Application Priority Data
Sep. 30, 2005 (EP) 05109104.9

(51) Int. Cl. G11B 7/24; G11B 7/00

(52) U.S. Cl. 369/111; 369/275.3

(57) ABSTRACT

The present invention relates to an optical storage disk for both read-only and (re-)writable applications comprising a plurality of adjacent track portions with a radial track pattern in which a number of n≧2 adjacent track portions repeatedly exhibit non-uniform radial track distances TP₁≠TP₂ . . . ≠TPₙ. The present invention further relates to an optical storage system comprising such a disk and an optical disk drive for it. The drive comprises a beam generator arranged to project a plurality of (n) satellite light spots (S₁, . . . , Sₙ; S_{L}, S_{M}) and one main spot (SR) onto said optical disk. In the system, the sum of the non-uniform radial track distances TP_{Σ}=TP₁+ . . . +TPₙ is higher than the reciprocal optical cutoff λ/(2 NA) of the beam.

The present invention relates to an optical storage disk for both read-only and (re-)writable applications having one or more tracks forming a plurality of adjacent track portions on the disk. It further relates to an optical storage system comprising an optical disk drive and such an optical storage disk.

In optical disk systems comprising such a disk and an optical disk drive, both radial and tangential densities of information stored on the disk are determined by the effective diameter of an optical spot Φ=λ/(2 NA) generated by a beam generator or pick-up unit (PUU) of the disk drive (reciprocally corresponding to the highest spatial frequency or so-called optical cutoff 2 NA/λ), where λ and NA represent the wavelength of the laser and the numerical aperture of the objective lens, respectively. For example, in Blu-ray disk (BD) systems, with λ=405 nm and NA=0.85, the spot size will be 4=238 nm, resulting in a minimum track pitch (distance between the centerlines of adjacent track portions, determining the radial density) TP*=238 nm and a minimum channel bit length T*_{ch}=59.6 nm. Note that the channel bit length T*_{ch}=59.6 nm corresponds to the optical cutoff, determining the tangential density, with d=1 binary run-length limited (RLL) channel code. That is to say, for any track pitch smaller than TP*, conventional push-pull tracking error signals (PP TES) will disappear, and for any bit length smaller than T*_{ch}, data information will fall out of the optical cutoff so that threshold detection definitely does not work any more. Note that for read-only disks, tracking is achieved by means of a so-called DTD (differential time detection) signal. The DTD signal looks at the combination of radial and tangential diffractions, so it also vanishes in the case of TP>TP*.

In the past years, higher storage densities have been achieved by further narrowing the channel bit length to below T*_{ch}, thanks to advanced signal processing techniques in which PRML (partial response maximum likelihood) detection plays a key role in tackling severe inter-symbol interference (ISI), see also A. V. Padiy et al, Signal processing for 35 GB on a single-layer Blu-ray disk, ODS2004, Monterey, Calif., 2004; and J. Lee et al, Advanced PRML data detector for high density recording, ODS2004, Monterey, Calif., 2004. However, the outcome of recent investigations by a number of companies shows that decreasing the channel bit length to below 50 nm gets extremely difficult, if not impossible, when using the BD optics in combination with the d=1 RLL channel code.

The other possibility, i.e. to push the density, lies in the radial direction, i.e., reducing track pitch. In connection with this, care must be taken to maintain a robust tracking ability when the track pitch approaches or even exceeds the optical limit.

For (re-)writable disks, there are basically two ways to effectively reduce track pitch. The first is to employ the land-groove format, as is known from DVD-RAM and (re-)writable HD DVD. By recording data both on lands and in grooves, the effective track pitch (land-to-groove distance) decreases by a factor of 2. The real track pitch (groove-to-groove distance) remains unchanged, which ensures robust tracking based on the conventional PP TES. Taking BD parameters as an example, if the real track pitch is the standard 320 nm, the effective track pitch is only 160 nm (compared to TP*=238 nm). Robust tracking, therefore, is not an issue in this case.

However, inter-track interference during reading (cross-talk), especially in the presence of aberrations like radial tilt and defocus, and, in the case of (re-)writable disks, cross-erase during writing (cross-write), becomes an issue. If tracks get closer together, cross-talk and cross-erase will become more pronounced. Cross-talk can be coped with electronically, for example, by the use of a 3-spot cross talk canceller that is able to remove the cross talk completely or partly depending on the track pitch, see for example U.S. Pat. No. 6,163,518. In that sense, cross-talk seems less problematic compared to cross-erase, because, roughly speaking, the latter destroys the data physically and makes it impossible to recover them during reading. Very accurate laser power control therefore is required in order to achieve proper cross-erase performance, which restricts the use of this type of systems.

Therefore, for reducing the cross-erase effect, particularly in consumer products, the groove-only format (like in CD-R/RW, DVD+R/RW or BD-R/RE) is preferred over the land-groove format, since adjacent tracks are better separated thermally in the groove-only case. Note that cross-talk is about equally severe for both land-groove and groove-only formats. Furthermore, for read-only disks, there is presently no possibility to increase the effective track by employing the land-groove format due to difficulties in mastering.

In order to alleviate as much as possible the efforts for improving the cross-erase performance, a person skilled in the art will naturally think of narrowing the track pitch while maintaining the groove-only format, which is actually the second way to effectively reduce the track pitch. Then the question is whether it is possible to retain reliable tracking error signals when the track pitch approaches the optical limit.

Known radial tracking error detection methods include push-pull radial tracking, in which a signal difference between two pupil halves is measured on separate detector elements; three-spot central aperture radial tracking, in which the radiation beam is split into three beams by a diffraction grating, projecting one center main spot and two outer satellite spots which are set a quarter track pitch off the main spot, the difference of their signals being used to generate the tracking error signal; three-spot push-pull radial tracking, in which the radiation beam is also split into three beams by a diffraction grating, but now a difference between the differential push-pull signals of the main spot and the satellite spots is used as the tracking error signal. Further differential phase or time detection (DPD or DTD) radial tracking methods are known from, for example, EP 1 453 039, in which the contribution of the radial offset of the phase is exploited in a square-shaped quadrant spot detector. However, all known radial tracking error methods are limited to the optical cutoff 2 NA/λ determined by the laser beam.

From European Patent Application 05100149.3 (12-01-2005; PHNL050027) and European Patent Application 05104676.1 (31-05-2005; PH000481) a concept is known, wherein a broad spiral format indirectly realizes tracking on track pitches below λ/(2 NA). The broad spiral consists of a number of tracks placed, relative to each other, at a spatial frequency higher than the optical cutoff. A guard-band separates two neighboring spirals. Its width is chosen to be comparable to the standard track pitch (around 300 nm for BD optics).

The concept was first adopted in the so-called Two DOS system (for read-only systems), where inter-track channel bits within one spiral are hexagonally aligned so that the bit information is jointly detected using multi-track readout. The disk capacity as well as the data rate increases significantly. Two spots are positioned on the edges of two outermost tracks, so as to be half on the track and half on the guard-band. Tracking is realized by looking at the light intensity difference between the projections of these two spots on detectors. The problem of tracking is solved in a joint manner, but the system is very expensive due to the heavy computational load of the joint bit detection and the need for multi-cavity lasers for (re-) writable format disks.

The concept was later modified according to European Patent Application 05100149.3 (12-01-2005; PHNL050027), where a single spot scans track by track within one spiral and thus normal one-dimensional detection is possible. The complexity of the detection process decreases, but a kind of switching action for getting appropriate tracking signals from multiple detectors takes place, because tracking is needed for every track, thus requiring the same number of spots and detectors as that of the tracks, as shown in European Patent Application 05104676.1 (31-05-2005; PH000481). This complication is also known from European Patent Application 05100149.3 (12-01-2005; PHNL050027), where a continuous spiral with small track pitches is broken regularly in order to virtually form a broad spiral enabling tracking.

Furthermore, with the concept of the broad spiral, new methods or structures for embedding timing and address information into (re-)writable format disks need to be invented, because any signals from the push-pull channel carried by a wobble structure embedded in the grooves of the disk become unreliable or even vanish as the track pitch within broad spirals approaches the optical cutoff or even falls below it. The wobble concept is not applicable any more for individual tracks.

It is an object of the present invention to provide an optical storage disk which allows the use of simple push-pull tracking while its spatial frequency approaches or even exceeds 2 NA/λ.

The object according to a first aspect of the invention is achieved by an optical storage disk comprising a plurality of adjacent track portions with a radial track pattern, in which a number of n≧2 adjacent track portions repeatedly exhibit non-uniform radial track distances TP₁≠TP₂ . . . ≠TPₙ.

Unlike conventional disk formats, in the present invention, tracks are not equidistantly spaced. Instead several different track distances TP₁ to TPₙ are introduced. In other words, n adjacent track portions with non-uniform radial track distances form a bundle which periodically repeats at a spatial bundle period TP_{Σ}=TP₁+ . . . +TPₙ₋₁+TPₙ. Therein, TP₁ to TPₙ₋₁ are the radial distances between the track portions within the bundle and TPₙ is the radial distance between the last (nth) track portion of a bundle and the adjacent first track portion of the next bundle. The bundle period may be still larger than λ/(2 NA), even when each of TP₁ to TPₙ falls below this lower limit. Thus, this new period can be used to achieve tracking. As a result, higher storage densities and better system robustness can be achieved, although the radial track distances are narrowed to below the optical cut-off limit.

According to a second aspect of the invention, which constitutes a further development of the first aspect, the track portions are arranged alternately at a first radial track distance TP₁ and at a second radial track distance TP₂ ≠TP₁ from each preceding track portion.

In this particular case, where the bundle only consists of two adjacent track portions (n=2), two alternating track pitches TP₁ and TP₂ form a spatial bundle period, TP_{Σ}=TP₁+TP₂, which may be larger than λ/(2 NA) even though TP₁ and TP₂ falls below this lower limit.

According to a further aspect of the invention, the object is achieved by an optical storage system comprising an optical storage disk according to the first or second aspect and an optical disk drive including a beam generator arranged to project a plurality of light spots onto said optical disk, wherein the sum of radial distances TP_{Σ}=TP₁+ . . . +TPₙ is higher than the reciprocal optical cutoff λ/(2 NA) of the pick-up unit.

Further embodiments of the invention are described by the features in the appendant claims.

The above and other objects, features and advantages of the present invention will become apparent from the following description of preferred embodiments thereof, taken in conjunction with the accompanying drawings, in which

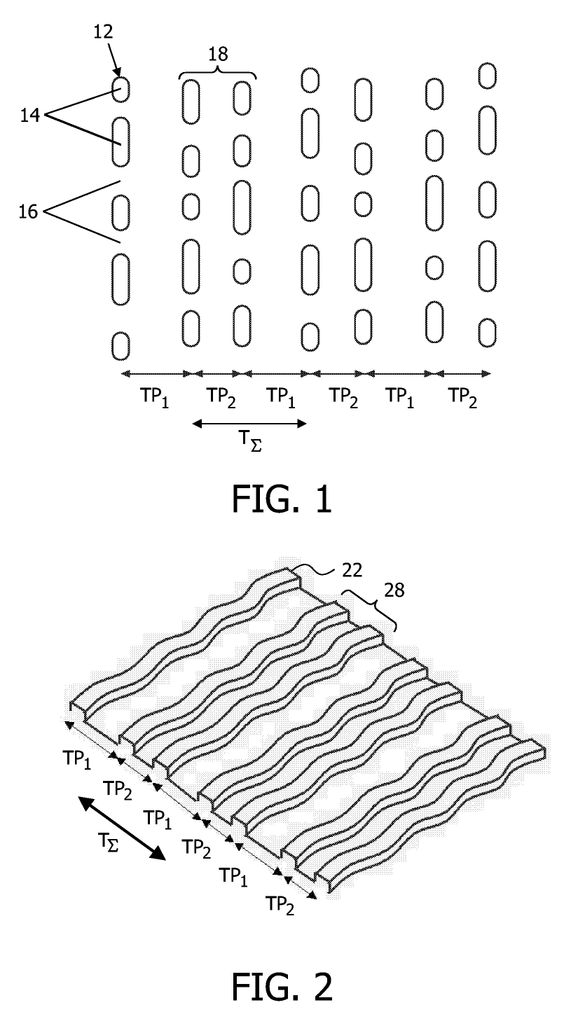

FIG. 1 shows a section of a read-only disk with non-uniform track pitches according to a first embodiment of the present invention;

FIG. 2 shows a perspective view of a section of a (re-)writable disk with non-uniform track pitches according to a second embodiment of the present invention;

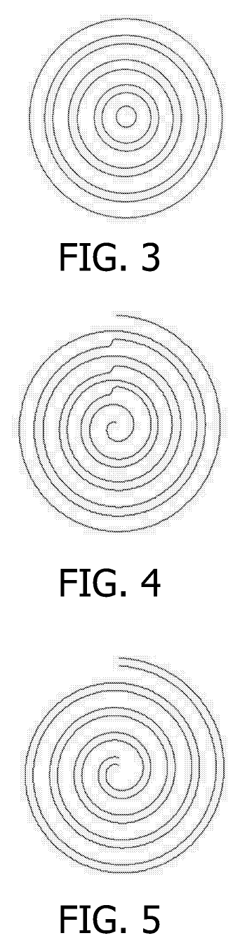

FIG. 3 illustrates schematically a disk structure with concentric tracks with a non-uniform track pitch;

FIG. 4 illustrates schematically a disk structure with one spiral track with a non-uniform track pitch structure;

FIG. 5 illustrates schematically a disk structure with two spiral tracks with a non-uniform track pitch structure;

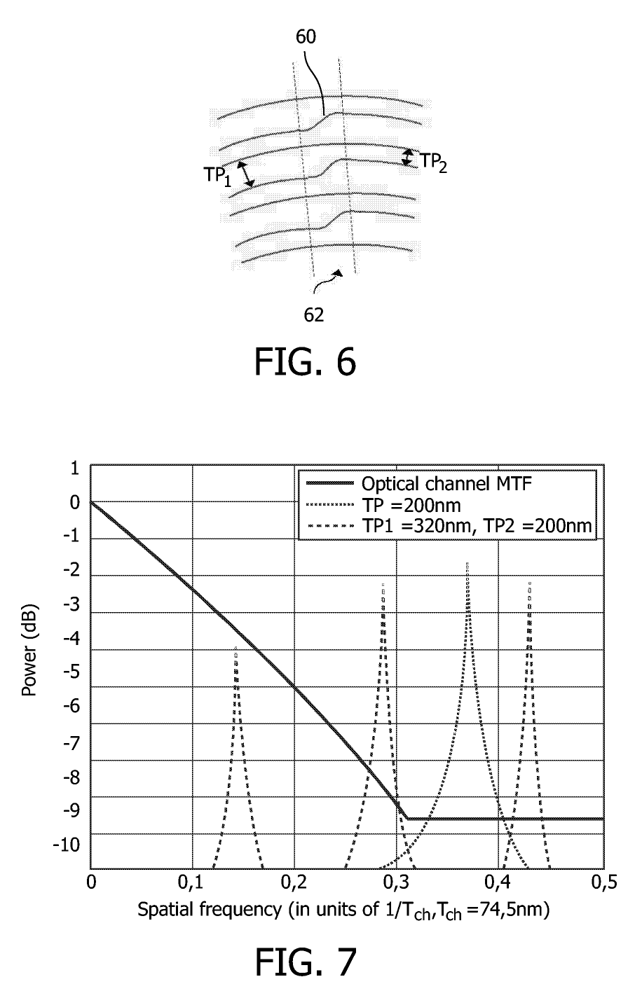

FIG. 6 shows a section of the disk structure according to FIG. 4 with transition zones between track portions of the spiral track; and

FIG. 7 is a graph showing a radial spatial frequency analysis of an embodiment of the present invention for Blu-ray optics;

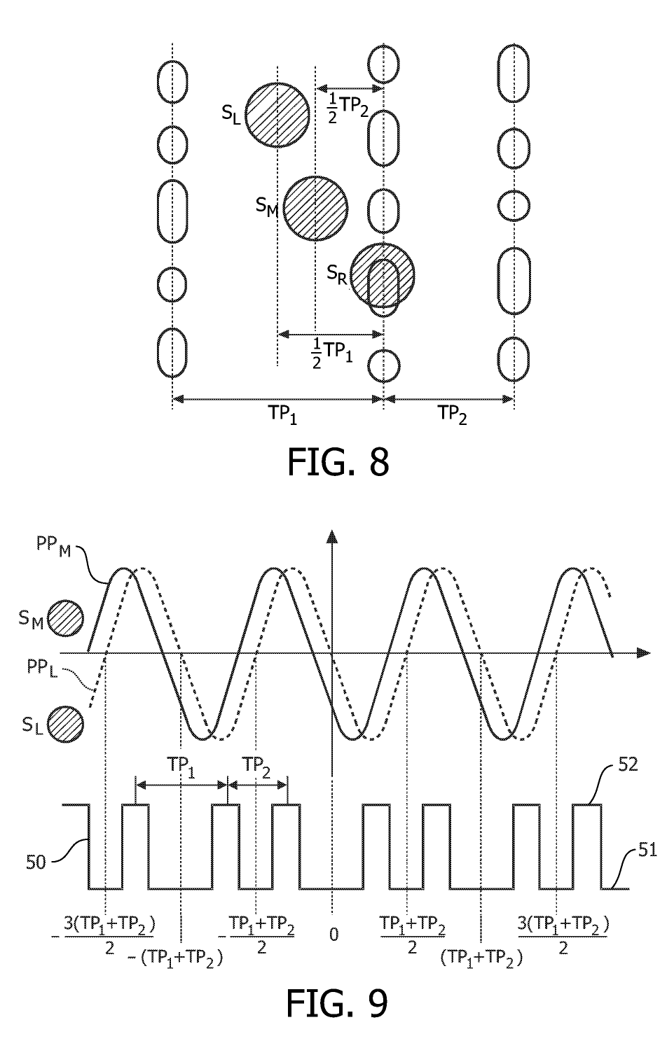

FIG. 8 illustrates schematically a disk structure and a three-spot set-up for reading, writing and tracking;

FIG. 9 is a diagram showing the push-pull signals from two tracking spots in FIG. 4;

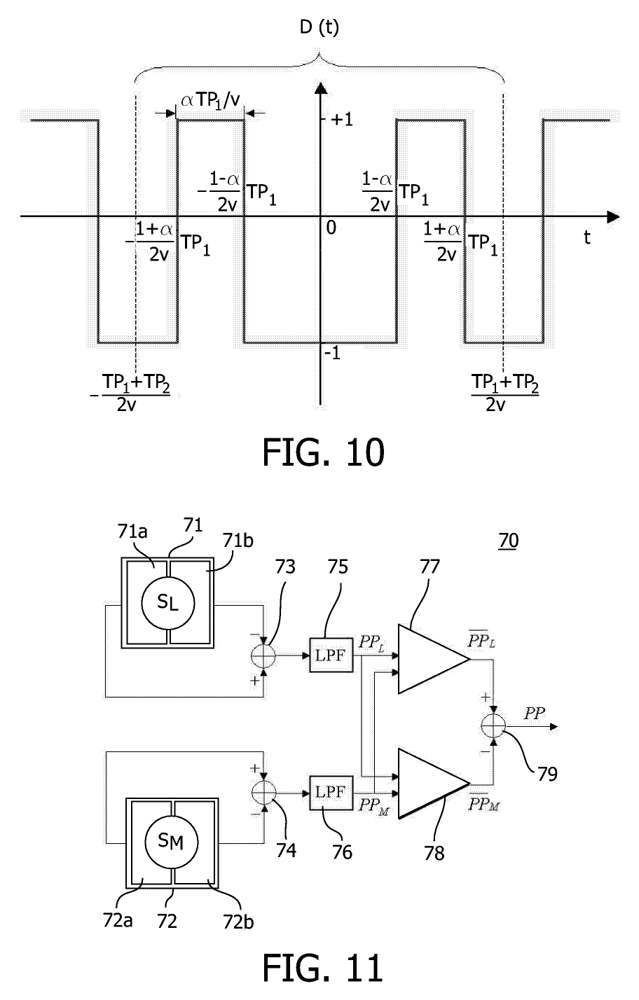

FIG. 10 shows a graph of a track structure function D (t);

FIG. 11 shows a schematic diagram of a push-pull tracking error signal generator; and

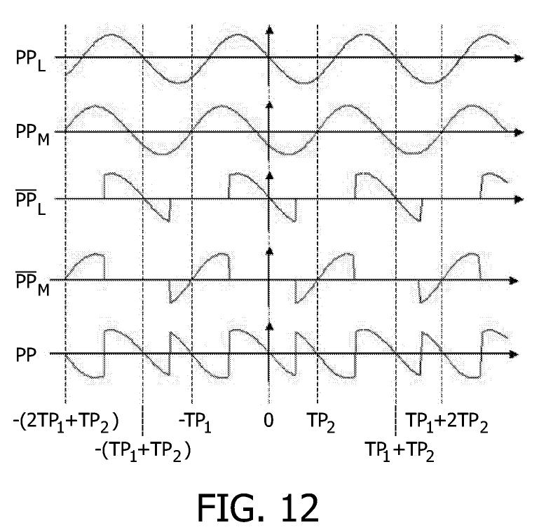

FIG. 12 illustrates signal waveforms generated by the generator set-up of FIG. 7.

The section of the disk according to the embodiment shown in FIG. 1 represents a read-only format disk. The track portions 12 therein are formed by trajectories of pits 14 and lands 16. Similarly in FIG. 2, a perspective view of a section 20 of a (re-)writable disk is shown, wherein the track portions are formed by wobbled pre-grooves 22. Such pre-grooves for tracking purposes in an unwritten optical disk are well known, for example, from CD-R/RW, DVD±R/RW or BD-R/RE standards and the like.

Track portions 12, 22 in both formats, the tangential trajectories of pits and lands in the read-only format and pre-grooves in the (re-)writable format, are not equidistantly spaced. Two different track pitches TP₁ and TP₂ are chosen so that each second track portion is placed at a first distance TP₁ from its neighboring track portion to the left and at a second distance TP₂ from its adjacent track portion to the right. In this way a bundle 18 and 28, respectively, of two adjacent track portions is formed, which repeats at a spatial (bundle) period TP_{Σ}=TP, +TP₂.

While for the conventional format, the uniform track pitch TP must satisfy TP>λ/(2 NA) because of the aforementioned reason, according to the invention, this problem is solved since instead of TP the spatial bundle period TP₁+TP₂ may be still (?) larger than λ/(2 NA) even when each of TP₁ to TPₙ falls below this lower limit. This spatial bundle period can be used to achieve tracking, as will be explained more clearly by an example with reference to FIG. 7.

The non-uniform track pitch structure in the new format can be realized in a number of ways. Three of them are depicted in FIGS. 3 to 5.

The embodiment of a disk according to FIG. 3 comprises a plurality of circular concentric tracks, each forming one of a plurality of single track portions. The concentric circles have radii with two alternating increment values. In this way a structure of alternating large and small track pitches (TP₁ and TP₂) is achieved. Such a structure simplifies the mastering process for such a disk structure, while it needs more jumps compared to a spiral structure during the operation of drives, and thus, has a relatively long access time.

In FIGS. 4 and 5, two other embodiments are illustrated utilizing a spiral track structure. In FIG. 4, a single continuous spiral track is shown. The spiral track forms adjacent quasi-circular track portions, wherein the pitch between one track portion and the next alternates between at least two values (TP₁ and TP₂). In order to form the non-uniform track pitch structure, a transition stage of a track is needed for every two rounds.

Such transition stages 60 are plotted in FIG. 6 at a magnified scale. The transition stages 60 are formed within a transition zone 62 at approximately a constant angular position with respect to the disk orientation. One can see that for (re-)writable disks with this structure the way of embedding and extracting address information can be almost copied from the currently existing disk systems. The steepness of the transition stage 60, and more precisely, its length given for two track pitches TP₁ and TP₂, is mainly determined by the requirement of the tracking servo behavior during the passing of this part. For example, it can be made constant for CLV (constant linear velocity) mode disks and increased from inner tracks to outer tracks for CAV (constant angular velocity) mode disks to simplify the tracking servo design. Basically, the transition stages will introduce extra disturbances to the servo loop, which could lead to undesired jumps. This can be solved, for example analogously to hard disk drives, by predicting the coming of the repetitive disturbances that are known beforehand (one transition for every two rounds at a fixed disk location) and then eliminating their impact in a feedforward way.

In FIG. 5, a pair of continuous spiral tracks wound in parallel at a first radial distance TP₁ forms the bundle of track portions. More precisely, the pair of spiral tracks form adjacent quasi-circular spiral portions, the pitch between one spiral portion and the next being TP_{Σ}=TP, +TP₂, with TP₂ ≠TP₁, resulting in the illustrated non-uniform track pitch structure.

Compared to the one in FIG. 4, this track pitch structure does not need transition parts, so that the process of mastering as well as the design of a tracking servo system becomes easier. The average access time is expected to be less, too. However, due to the fact that the track portions are now separated into two spiral tracks that are spatially independent, a new way of addressing needs to be considered. It could be, for example, similar to that used in land-groove format disks.

In FIG. 7, the spectra of different radial spatial structures according to an embodiment of the present invention for Blu-ray optics are plotted. For comparison, the optical channel modulation transfer function (MTF) based on the Braat-Hopkins formula is also plotted (solid line); this has an optical cutoff around 0.3127 in the units of 1/T_{ch} (T_{ch}=74.5 nm). The dotted curve indicates the spatial frequency position with TP₁=200 nm. Obviously, it is already beyond the cutoff so that conventional tracking becomes impossible. Choosing the track pitch structure of one of the FIGS. 1 to 6 with TP₁=320 nm and TP₂=200 nm, one can see that a frequency component of about 0.14 corresponding to TP_{Σ}=TP, +TP₂=520 nm appears as a spike (dashed curve) below the cutoff within the optical passband. This frequency component can be used for the tracking purpose.

One of the possible ways to make use of this spatial frequency component for tracking purposes is illustrated in FIG. 8. Three laser spots are employed, a main spot S_{R} on the right for reading and/or writing and two satellite spots S_{M} and S_{L} in the middle and on the left, respectively, for tracking. When S_{R} is exactly aligned with the target track, S_{M} and S_{L} are located

$$\frac{1}{2} {TP}_{2} and \frac{1}{2} {TP}_{1}$$

off the target track, respectively. In other words, the satellite spots S_{M} and S_{L} are displaced by different paths,

$$\frac{1}{2} {TP}_{2} and \frac{1}{2} {TP}_{1} ,$$

respectively, in a radial direction away from the main spot S_{R}.

The three spots can be generated by, for example, a diffraction grating assembly for splitting a single laser beam into three beams and directing them in radially displaced directions on the disk, and a single or separate objective lens for controlling the focus of the beams. As usual, the two tracking spots can have a much lower light intensity than the read/write spot, and they should additionally be placed at a certain distance from each other in the tangential direction with respect to the tracks to prevent interference, as illustrated in FIG. 8. While said disk is radially scanned, push-pull signals are derived from the reflections of the spots S_{M} and S_{L}, utilizing a tracking error detection device as described in more detail with reference to FIG. 11.

In this way, two curves with the same shape will be obtained, having a period of

T=TP₁+TP₂

and a phase difference of

$$Δ φ = π \frac{{TP}_{1} - {TP}_{2}}{{TP}_{1} + {TP}_{2}} .$$

The push-pull signals will exist as long as the following conditions

$$T > \frac{λ}{2 NA} and {TP}_{1} \neq {TP}_{2} \qquad ( 1 )$$

are satisfied.

An example of these two push-pull signals is shown in the upper part of FIG. 9. In the lower part the corresponding traversed track structure 50 is given which exhibits land areas (or inter-track spacing) 51 between tracks and groove areas 52 actually forming tracks. Although, for better intelligibility, the land-groove structure of (re)writable disks is chosen in this example, it is to be noted that, similarly to the situation in FIG. 8, the invention also applies to read-only format disks having a pit-land structure without pre-grooves.

In the upper part of FIG. 9, the solid curve is the push-pull signal PP_{M} belonging to the spot S_{M} and the dashed curve is the push-pull signal PP_{L} belonging to the spot S_{L}. As can be seen from curve 50, in the middle of each land area 51 the track pattern is symmetric in the radial direction although track pitches are not uniform. When either spot is located right above the middle of a land area, the related push-pull signal, consequently, becomes zero. Note that the depicted traversing track structure 50 in the lower part of FIG. 9 is aligned with the push-pull signal PP_{L} of S_{L}.

Due to the radial displacement of

$$\frac{1}{2} {TP}_{2} and \frac{1}{2} {TP}_{1}$$

off the main spot S_{R}, the main spot S_{R} is on track every second time a zero-crossing appears in PP_{M} and every second time a zero-crossing appears in PP_{L}. In the example of FIG. 9, S_{R} is on track when PP_{L} crosses zero with a negative slope; of course, the sign of the slope can be arbitrarily chosen by means of appropriate signal processing. Thus, the full tracking information is already contained in the aggregate of all push-pull signals PP_{M} and PP_{L}.

With a uniform track pitch the track pattern is symmetric in the radial direction, also in the middle of each groove area and, therefore, the push-pull signal becomes zero not only when the spot is located in the middle between tracks but also in the center of a track. According to the invention, as pointed out above, due to the radial asymmetry of the tracks, only the middle of the inter-track spacing is distinguished. It is to be noted that, unlike the illustration in FIG. 9, an extra zero crossing might appear somewhere between the centerlines of adjacent land areas, at which reflected light intensities on the two halves of the detector get balanced. However, this push-pull zero point can be eliminated by properly tuning the ratio of TP₁ and TP₂ as well as the duty cycle. The generally required condition is written as follows:

$$\frac{\partial h ( t )}{\partial t} * {\sum }_{n = - ∞}^{∞} D ( t - n \frac{{TP}_{1} + {TP}_{2}}{v} ) = 0 , only when \\ t = \pm N \frac{{TP}_{1} + {TP}_{2}}{2 v} , N = 0 , 1 , 2 , … . \qquad ( 2 )$$

Therein h(t) represents the time domain impulse response of the optical channel, * the convolution and v the traversing velocity of the spot. D(t) is a function describing the track structure within one period, that is, from

$$- \frac{{TP}_{1} + {TP}_{2}}{2} to \frac{{TP}_{1} + {TP}_{2}}{2}$$

$$D ( t ) = \{ \begin{matrix}\begin{matrix}- 1 , \\ \\ \end{matrix} & \begin{matrix}\begin{matrix}t ∈ [ - \frac{{TP}_{1} + {TP}_{2}}{2 v} , - \frac{1 + α}{2 v} {TP}_{1} ) , \\ [ - \frac{1 - α}{2 v} {TP}_{1} , \frac{1 - α}{2 v} {TP}_{1} ] ,\end{matrix} \\ ( \frac{1 + α}{2 v} {TP}_{1} , \frac{{TP}_{1} + {TP}_{2}}{2 v} ] ,\end{matrix} \\ \begin{matrix}+ 1 , \\ \end{matrix} & \begin{matrix}t ∈ [ - \frac{1 + α}{2 v} {TP}_{1} , - \frac{1 - α}{2 v} {TP}_{1} ) , \\ ( \frac{1 - α}{2 v} {TP}_{1} , \frac{1 + α}{2 v} {TP}_{1} ] .\end{matrix}\end{matrix} \qquad ( 3 )$$

The function D(t) is illustrated in FIG. 10, where +1 corresponds to the track area and −1 corresponds to the inter-track spacing. The track width is set at α TP₁, with 0<α<1, uniformly over the whole disk. In order to meet the condition in (2), the difference between TP₁ and TP₂ can be adjusted, for example, TP₂=TP₁/2. In general, the track pitch combination TP₁ and TP₂ can be chosen in dependence on various requirements, such as the disk capacity, the quality of tracking signals and cross-erase and cross-talk constraints.

Although all tracking information is contained in the aggregate of the push-pull signals PP_{M} and PP_{L}, a common radial tracking error signal might be preferred, which should be zero when the main reading/writing spot S_{R} sits on top of the target track, and non-zero elsewhere. Because of the non-uniform track pitches, the distances between two adjacent zeros of such a signal must alternately take the value of TP₁ and TP₂. However, any one of the two push-pull signals cannot be utilized by itself as a radial tracking error signal, since both of them have a period of TP₁+TP₂, i.e., the distance between neighboring zeros is (TP₁+TP₂)/2. Furthermore, due to the signal symmetry, only every second zero-crossing signalizes alignment of the main spot, as can be seen in FIG. 9. Therefore, the push-pull signals PP_{M} and PP_{L} have to be appropriately combined to a common tracking error signal.

Such a combination can be implemented, for example, in a tracking error detection device 70, as shown schematically in FIG. 11. Some of the accordingly processed signals are depicted in FIG. 12. Again, the setup with two tracking spots S_{M} and S_{L}, as shown in FIG. 8, is applied. The spots are reflected by the disk and projected onto two photodetectors 71, 72 of the tracking error detection device 70. Each detector 71, 72 comprises two separate detector elements 71a, 71b and 72a, 72b, aligned in the tangential direction with the track, in accordance with present standards, for measuring the signal difference between two pupil halves of the spots on separate detector elements. Their outputs, corresponding to the amount of light reflected onto each of the elements, are processed in separate push-pull signal generators, each assigned to one of the detectors. Each push-pull signal generator comprises one mixer 73, 74 coupled to the assigned detector and one low-pass filter 75, 76 to which the differential output of the assigned mixer is fed. After low-pass filtering, proper differential push-pull signals PP_{L} (from the spot S_{L}) and PP_{M} (from the spot S_{M}) are obtained and fed into a signal combiner. The signal combiner comprises two amplitude comparators 77 and 78, being inversely coupled to each of the low-pass filter outputs. The amplitude comparator 77 outputs a signal PP_{L} which corresponds to the value of PP_{L} if PP_{L}>PP_{M}, and is 0 otherwise, while the amplitude comparator 78 outputs a signal PP_{M} which is 0 when PP_{L}>PP_{M} and which corresponds to the value of PP_{M} otherwise. The signal combiner further comprises a mixer 79 which finally subtracts the resulting output signals PP_{L} and PP_{M}, delivering the common radial tracking error signal PP= P̅P̅_{L}− P̅P̅_{M}.

In the waveforms of FIG. 12, which are based on the push-pull signals obtained from a track-pitch structure as shown in FIG. 9, one can see that the distances between zero-crossings of the resulting tracking error signal PP are alternately TP₁ and TP₂, i.e. they correspond to the track pitches. Tracking error detection on non-uniformly spaced tracks is thus realized.

Taking Blu-ray optics as an example and assuming

$${TP}_{2} = \frac{{TP}_{1}}{2} ,$$

the new tracking error signal exists as long as TP₂≧80 nm, compared to the lower limit of the track pitch TP*=238 nm in the current disk formats. As a result, higher storage densities and better system robustness can be achieved while push-pull type tracking methods are still applicable.

It is to be noted that the device and the signals shown in FIGS. 11 and 12 represent only one of a number of possible ways to process the push-pull signals of both tracking spots S_{M} and S_{L} in order to derive tracking information. In particular, there are many other possibilities to combine push-pull signals PP_{L}, PP_{M}, or in general, any number of push-pull signals PP₁, . . . , PPₙ.

The format according to the invention makes the cross-erase and cross-talk related issues independent of the tracking problem. It is possible to conduct a media evaluation, for example in (re-)writable disks, to improve the cross-erase effect without considering any constraints on the tracking side. The tracking method is based on the combination of standard push-pull signals of two laser spots and enables robust tracking as well as addressing and timing recovery when track pitches approach or even exceed the conventional optical limit. As a result, higher storage densities can be achieved utilizing an established and only slightly modified tracking technology.

Another advantage is achieved in timing recovery and addressing. As is well known, in many present (re-)writable disk formats (like CD-R/RW, DVD+R/RW or BD-R/RE), a wobble is embedded in the grooves for carrying the timing and address information. Since it is formed by means of a track deviation from its central line, the wobble can be detected from the push-pull channel.

Yet another advantage is that embedding timing and address information into a (re-)writable disk by way of a wobble structure still applies and, thus, the addressing of individual tracks is preserved. The only difference is that due to the tracking being done at inter-groove spacing, the information is carried by wobbled lands instead of grooves, which can be solved in a modified mastering process.

Although, by way of example, disks are shown and described herein having two different alternating radial track distances, TP₁ and TP₂, the invention also relates to disks having more than two adjacent track portions forming a bundle. In general, n adjacent track portions can be arranged at non-uniform radial track distances (TP₁, . . . , TPₙ₋₁) forming a bundle of track portions such that the bundle periodically repeats at a radial distance of TP_{Σ}=TP₁+ . . . +Tₙ. In this case, a frequency component corresponding to TP_{Σ}=TP₁+ . . . +TPₙ will be detected which can be used for the tracking purpose in the same manner as described above.

1. Optical storage disk comprising a plurality of adjacent track portions with a radial track pattern in which a number n≧2 of adjacent track portions periodically exhibit non-uniform radial track distances TP₁≠TP₂ . . . ≠TPₙ.

2. Optical storage disk according to claim 1,
characterized in that the track portions are arranged alternately at a first radial track distance TP₁ and at a second radial track distance TP₂≠TP₁ from each preceding track portion.

3. Optical storage system according to claim 2,
characterized in that TP₂=TP₁/2.

4. Optical storage disk according to claim 2, characterized in that the track portions are formed by circular concentric tracks having radii with two alternating increment values (TP₁ and TP₂≠TP₁).

5. Optical storage disk according to claim 2, characterized in that one spiral track forms adjacent quasi-circular track portions, whereby the pitch between one track portion and the next alternates between two values TP₁ and TP₂≠TP₁.

6. Optical storage disk according to claim 5, characterized in that each second track portion of said adjacent quasi-circular track portions comprises a transition stage formed within a transition zone at approximately a constant angular position with respect to the disk orientation.

7. Optical storage disk according to claim 2, characterized in that the disk comprises a pair of spiral tracks winded in parallel at a first radial distance TP₁, thereby forming adjacent quasi-circular spiral portions, whereby the pitch between one spiral portion and the next is TP_{Σ}=TP, +TP₂, wherein TP₂≠TP₁.

8. Optical storage disk according to claim 1, characterized in that the disk is a recordable format disk, wherein the tracks are formed by pre-grooves.

9. Optical storage disk according to claim 1, characterized in that the disk is a read-only format disk, wherein the tracks are formed by the trajectories of pits and lands.

10. Optical storage system comprising an optical storage disk according to claim 1 and an optical disk drive comprising a beam generator arranged to project a plurality of light spots (S₁, . . . , Sₙ; S_{L}, S_{M}, S_{R}) onto said optical disk, characterized in that a sum of the non-uniform radial track distances TP_{Σ}=TP₁++TPₙ is higher than the reciprocal optical cutoff λ/(2 NA) of the beam.

11. Optical storage system according to claim 9, characterized in that the track portions are arranged alternately at a first radial track distance TP₁ and at a second radial track distance TP₂≠TP₁ from each preceding track portion and that the optical disk drive is arranged to scan said optical storage disk in radial direction with the traversing velocity v such that the following condition is fulfilled
$$\frac{\partial h ( t )}{\partial t} * {\sum }_{n = - ∞}^{∞} D ( t - n \frac{{TP}_{1} + {TP}_{2}}{v} ) = 0 , only when$$
$$t = \pm N \frac{{TP}_{1} + {TP}_{2}}{2 v} , N = 0 , 1 , 2 , … ,$$
wherein h(t) represents the time domain impulse response of an optical channel,
* represents the convolution and
$$D ( t ) = \{ \begin{matrix}\begin{matrix}- 1 , \\ \\ \end{matrix} & \begin{matrix}\begin{matrix}t ∈ [ - \frac{{TP}_{1} + {TP}_{2}}{2 v} , - \frac{1 + α}{2 v} {TP}_{1} ) , \\ [ - \frac{1 - α}{2 v} {TP}_{1} , \frac{1 - α}{2 v} {TP}_{1} ] ,\end{matrix} \\ ( \frac{1 + α}{2 v} {TP}_{1} , \frac{{TP}_{1} + {TP}_{2}}{2 v} ] ,\end{matrix} \\ \begin{matrix}+ 1 , \\ \end{matrix} & \begin{matrix}t ∈ [ - \frac{1 + α}{2 v} {TP}_{1} , - \frac{1 - α}{2 v} {TP}_{1} ) , \\ ( \frac{1 - α}{2 v} {TP}_{1} , \frac{1 + α}{2 v} {TP}_{1} ] .\end{matrix}\end{matrix}$$
is a function describing the radial track pattern within one period from
$$- \frac{{TP}_{1} + {TP}_{2}}{2} to \frac{{TP}_{1} + {TP}_{2}}{2} ,$$
where +1 corresponds to the track area and −1 the inter-track spacing and the track width is set αTP₁ with 0<α<1 uniformly over the whole optical storage disk.
